(19) United States
(12) Patent Application Publication
(10) Pub. No.: US 2004/0192556 A1
(43) Pub. Date: Sep. 30, 2004

(54) Crop oil adjuvants

(76) Inventors: Sandra Denise Schregenberger, Hillsborough, NJ (US); Bruce R. Lundmark, Waller, TX (US); Geoffrey Peter Matheson, Belmoral (AU); John Edmund Drew, Sunnybank (AU); John A. Webber JR., Tulsa, OK (US)

Correspondence Address: MOSER, PATTERSON & SHERIDAN, L.L.P., 3040 POST OAK BOULEVARD, SUITE 1500, HOUSTON, TX, 77056, US

(21) Appl. No.: 10/738,126

(22) Filed: Dec. 17, 2003

Related U.S. Application Data
(60) Provisional application No. 60/433,941, filed on Dec. 17, 2002.

(51) Int. Cl. A01N 25/10

(52) U.S. Cl. 504/361

(57) ABSTRACT

An adjuvant crop oil concentrate comprising a polyalphaolefin and a surfactant. A method of using the crop oil concentrate in conjunction with a pesticide. A method of reducing or eliminating undesired plants by post-emergence application of a crop oil concentrate comprising a polyalphaolefin and a surfactant in conjunction with an herbicide.

This application claims priority of U.S. Provisional Patent Application Ser. No. 60/433,941, filed Dec. 17, 2002, which is hereby incorporated by reference.

### FIELD OF INVENTION

The present invention relates to the field of crop oil adjuvants. More particularly, the present invention relates to crop oil concentrates.

In order to enhance or modify the chemical and/or physical characteristics of certain pesticides, certain materials are added to form a mixture for spraying. Generally referred to as adjuvants, these materials generally have no pesticidal activity of their own. Since spray application can be critical to the performance of the agricultural chemical, adjuvants are added to reduce application problems such as chemical stability, incompatibility, solubility, suspension, foaming, drift, evaporation, volatilization, phytotoxicity, surface tension, droplet size and coverage. They can, depending on their type, enhance wetting, spreading, sticking, emulsifying, dispersing and biological activity. Adjuvants include wetting agents, crop oil concentrates, spreaders, stickers, buffering agents, foaming and anti-foaming agents, dispersing agents and drift control agents. These are recommended for one of two reasons—or both. First, to enhance biological activity of the pesticide and second, to reduce, minimize or eliminate spray application problems as noted previously.

Oil based adjuvants are commonly used in conjunction with pesticide formulations to enhance the performance of the active ingredients, including herbicides, insecticides and fungicides. There are a number of classes of herbicide adjuvants, including crop oil concentrates (COCs). COCs are typically formulated with paraffinic petroleum-based oils and a non-ionic surfactant. One use of COCs is to enhance the weed control efficacy of post-emergence herbicides. Although not wishing to be bound by any particular theory, it is currently believed that the oil component of the COCs functions by increasing herbicide penetration into the waxy cuticle. The surfactant component emulsifies the oil in the spray solution and reduces surface tension for improved wetting. Additionally, crop oil concentrates have also been used as a drift control device in which the spray droplets maintain larger size and drift less from the desired target. An effective crop oil should have low volatility for reduced evaporation of the solution from the leaf, low water solubility to resist rain wash-off, and low surface tension for easier atomization and good surface coverage.

A need exists for improved COCs that provide one or more of reduced volatility, lower water solubility, low surface tension, improved surface coverage and efficacy of an active ingredient, i.e., a pesticide.

### SUMMARY

The present invention provides an improved crop oil concentrate, having a polyalphaolefin that offers several benefits over the prior art.

One embodiment according to the present invention provides a crop oil concentrate comprising a polyalphaolefin (PAO) having a viscosity ranging from about 0.1 to about 10 cSt at 100° C. and a surfactant. In one embodiment according to the present invention, the PAO has a viscosity of about 2 cSt at 100° C.

Another embodiment according to the present invention provides a COC having a surfactant and a PAO having a pour point less than or equal to about minus 48° C.

Another embodiment according to the present invention provides a COC having a surfactant and a PAO having a number average molecular weight ranging from about 110 to about 700.

Another embodiment according to the present invention provides a COC comprising a surfactant and a PAO comprising an oligomer of at least one linear alphaolefin, wherein the linear alphaolefin has from about 8 to about 16 carbon atoms.

Another embodiment according to the present invention provides a COC having water, a surfactant and a PAO having a viscosity ranging from about 0.1 to about 10 cSt at 100° C. to be used with a pesticide. In another embodiment according to the present invention, the PAO has a viscosity of about 2 cSt at 100° C.

### DETAILED DESCRIPTION

The present invention provides an improved crop oil concentrate, having a polyalphaolefin that offers several benefits over the prior art.

Specific Embodiments

Certain specific embodiments are described below. Various terms in the claims are defined herein. To the extent a term used in a claim is not defined below, or elsewhere herein, it should be given the broadest definition persons in the pertinent art have given that term as reflected in printed publications and issued patents.

One or embodiments includes a crop oil concentrate comprising a polyalphaolefin and a surfactant, wherein the polyalphaolefin preferably has a viscosity ranging from about 0.1 cSt to about 10 cSt. Also, the polyalphaolefin is preferably an oligomer of at least one linear alphaolefin that has 8 or more carbon atoms, more preferably from 8 to 16 carbon atoms.

In one or more embodiments, the crop oil concentrate identified above or elsewhere herein has a polyalphaolefin with a viscosity ranging from about 1.5 cSt to about 2.5 cSt.

In one or more embodiments, the crop oil concentrate identified above or elsewhere herein preferably has a pour point less than or equal to about −48° C.

In one or more embodiments, the crop oil concentrate identified above or elsewhere herein preferably has a polyalphaolefin with a number average molecular weight ranging from about 110 to about 700.

In one or more embodiments, the crop oil concentrate identified above or elsewhere herein preferably includes a polyalphaolefin that includes an oligomer (e.g., is prepared from) of at least one linear alphaolefin, wherein the linear alphaolefin has from 8 to 14 carbon atoms.

In one or more embodiments, the crop oil concentrate identified above or elsewhere herein preferably includes a surfactant that is an anionic surfactant.

In other embodiments, the crop oil concentrate identified above or elsewhere herein includes a surfactant that is a non-ionic surfactant.

In one or more embodiments, the crop oil concentrate identified above or elsewhere herein includes a surfactant that is a cationic surfactant.

In one or more embodiments, the crop oil concentrate identified above or elsewhere herein includes a surfactant that includes tallow amine ethoxylate.

In one or more embodiments, a crop oil concentrate can include a polyalphaolefin, a surfactant and a pesticide.

In one or more embodiments, the crop oil concentrate identified above or elsewhere herein preferably includes a polyalphaolefin having a viscosity ranging from about 0.1 cSt to about 10 cSt.

In one or more embodiments, the crop oil concentrate identified above or elsewhere herein preferably has a viscosity ranging from about 1.5 cSt to about 2.5 cSt.

In one or more embodiments, the crop oil concentrate identified above or elsewhere herein preferably includes a surfactant that is a non-ionic surfactant.

In one or more embodiments, the crop oil concentrate identified above or elsewhere herein preferably includes a surfactant that is an anionic surfactant.

In one or more embodiments, the crop oil concentrate identified above or elsewhere herein preferably includes a polyalphaolefin having a pour point less than or equal to about −48° C.

In one or more embodiments, the crop oil concentrate identified above or elsewhere herein preferably includes a polyalphaolefin having a number average molecular weight ranging from about 110 to about 700.

In one or more embodiments, the crop oil concentrate identified above or elsewhere herein preferably includes an oligomer of at least one linear alphaolefin and wherein the linear alphaolefin has from about 8 to about 16 carbon atoms.

One or more embodiments includes a crop oil concentrate that includes a polyalphaolefin, a surfactant, and water, wherein the polyalphaolefin has a viscosity ranging from about 0.1 cSt to about 10 cSt. Preferably, the polyalphaolefin is an oligomer of at least one linear alphaolefin that has 8 or more carbon atoms, more preferably from 8 to 16 carbon atoms.

In one or more embodiments, the crop oil concentrate identified above or elsewhere herein preferably has a polyalphaolefin with a viscosity ranging from about 1.5 cSt to about 2.5 cSt.

In one or more embodiments, the crop oil concentrate identified above or elsewhere herein preferably includes a polyalphaolefin having a pour point less than or equal to about −48° C.

In one or more embodiments, the crop oil concentrate identified above or elsewhere herein preferably includes a polyalphaolefin with a number average molecular weight ranging from about 110 to about 700.

In one or more embodiments, the crop oil concentrate identified above or elsewhere herein preferably includes a polyalphaolefin of (e.g., is formed from or that includes) an oligomer of at least one linear alphaolefin having from about 8 to about 16 carbon atoms.

In one or more embodiments, the crop oil concentrate identified above or elsewhere herein preferably includes a surfactant that is a non-ionic surfactant or an anionic surfactant.

In one or more embodiments, the crop oil concentrate identified above or elsewhere herein preferably includes a surfactant that is a non-ionic surfactant.

In one or more embodiments, the crop oil concentrate identified above or elsewhere herein preferably includes a conventional oil, a surfactant and a PAO having a viscosity ranging from about 1 cSt to about 10 cSt, wherein the PAO comprises more than about 25 wt % of the total weight of the conventional oil and the PAO in the crop oil concentrate.

In one or more embodiments, the crop oil concentrate identified above or elsewhere herein has a PAO with a viscosity ranging from about 1.5 cSt to about 2.5 cSt.

In one or more embodiments, the crop oil concentrate identified above or elsewhere herein preferably includes a PAO including more than about 50 wt % of the total weight of the conventional oil and the PAO in the crop oil concentrate.

One or more specific embodiments of the invention is directed to a method of inhibiting growth of a weed, the method including mixing a PAO having a viscosity ranging from about 1 cSt to about 10 cSt at 100° C. with a surfactant to form a crop oil concentrate; blending the crop oil concentrate with a mixture of a carrier and a herbicide to form a herbicide solution; and applying the herbicide solution to a field having the weed. Preferably, the PAO includes an alphaolefin with 8 or more carbon atoms

In one or more embodiments, the method described above or elsewhere herein has a PAO with a viscosity ranging from about 1.5 cSt to about 2.5 cSt.

In one or more embodiments, the method described above or elsewhere herein includes mixing a surfactant, a herbicide and a PAO having a viscosity ranging from about 1 cSt to about 10 cSt at 100° C. to form a crop oil concentrate, blending the crop oil concentrate with a carrier and a herbicide to form a herbicide solution, and applying the herbicide solution to a field having the weed.

One or more specific embodiments is directed to a pesticide composition that includes a PAO having a viscosity ranging from about 1 cSt to about 10 cSt, a pesticide and a surfactant.

In one or more embodiments, the pesticide composition identified above or elsewhere herein preferably includes a PAO with a viscosity ranging from about 1.5 to about 2.5 cSt.

In one or more embodiments, the crop oil concentrate identified above or elsewhere herein preferably includes a polyalphaolefin that includes an oligomer formed from or including at least one linear alphaolefin having from 6 to 12 carbon atoms.

In one or more embodiments, the crop oil concentrate identified above or elsewhere herein preferably includes a polyalphaolefin that includes an oligomer formed from or including at least one linear alphaolefin having from 8 to 10 carbon atoms.

In one or more embodiments, the crop oil concentrate identified above or elsewhere herein preferably includes a polyalphaolefin having a viscosity of 4 cSt or less.

In one or more embodiments, the crop oil concentrate identified above or elsewhere herein preferably includes a polyalphaolefin having a viscosity ranging from 1 cSt to 4 cSt.

In one or more embodiments, the crop oil concentrate identified above or elsewhere herein preferably includes a polyalphaolefin having a viscosity of 5 cSt or less.

In one or more embodiments, the crop oil concentrate identified above or elsewhere herein preferably has a viscosity of 13 cSt or less.

In one or more embodiments, the crop oil concentrate identified above or elsewhere herein preferably has a viscosity of 8 cSt or less.

The crop oil concentrate may have other viscosities, depending on the viscosities and amounts of the polyalphaolefin, surfactant and other components. For example, in certain embodiments, the crop oil concentrate has a viscosity within a particular range, i.e., having an upper limit and a lower limit. Examples of upper limits are crop oil concentrates with a viscosity of 13 or below; or 8 or below; or 7 or below; or 5.5 or below; or 4.5 or below; or 4 or below; or 3.1 or below. In certain embodiments that involve a range of viscosities, the crop oil concentrate may have any of the aforementioned upper limits, together with any of the following lower limits: a viscosity of 11 or above; or 6 or above; or 5 or above; or 3.5 or above; or 2.5 or above; or 2 or above; or 1.1 or above. The aforementioned viscosities are in cSt, measured at 100 degrees C.

In one or more embodiments, the crop oil concentrate identified above or elsewhere herein can include a surfactant that includes an ethoxylate or ester.

In one or more embodiments, the surfactant of the crop oil concentrate identified above or elsewhere herein can include a member selected from the group consisting of alkyl phenol ethoxylates (Nonyl, Dinonyl, Octyl, and Dodecyl phenols) having from about 4 and about 10 moles of ethylene oxide; alcohol ethoxylates (Linear C-12 to C-18 alcohols) having about 4 to about 10 moles of ethylene oxide; sorbitan esters (Sorbitan mono, di and tri oleates; Sorbitan mono, di- and tri-laureates) and their reaction products incorporating from about 15 to about 20 moles of ethylene oxide; alkyl polyglycosides; organo silicone surfactants; amides; and a block copolymer of ethylene oxide and propylene oxide.

In one or more embodiments, the surfactant of the crop oil concentrate identified above or elsewhere herein can include an alcohol or phenol.

In one or more embodiments, the surfactant of the crop oil concentrate identified above or elsewhere herein can include phosphate esters of alkyl phenols and alcohol ethoxylates and carboxylates of the alkyl phenols and alcohol ethoxylates.

In one or more embodiments, the crop oil concentrate identified above or elsewhere herein can include a defoamer.

In one or more embodiments, the crop oil concentrate identified above or elsewhere herein can include a siloxane compound.

In one or more embodiments, the crop oil concentrate identified above or elsewhere herein can include dimethyl siloxane.

In one or more embodiments, the crop oil concentrate identified above or elsewhere herein can include a fatty acid.

In one or more embodiments, the crop oil concentrate identified above or elsewhere herein can include a defoamer and a fatty acid.

One or more embodiments is directed to a pesticide composition that includes a pesticide and a polyalphaolefin.

In one or more embodiments, the pesticide composition identified above or elswhere herein further includes water.

In one or more embodiments, the pesticide composition identified above or elswhere herein further includes a surfactant.

In one or more embodiments, the pesticide composition identified above or elswhere herein further includesa a polyalphaolefin having a viscosity of 4 cSt or less.

In one or more embodiments, the pesticide composition identified above or elswhere herein includes a pesticide that is a herbicide. In one or more embodiments, the herbicide is or includes a triazine compound. In other embodiments, the herbicide is or includes a phenoxy compound. In yet other embodiments, the herbicide is or includes an amine salt compound. In still other embodiments, the herbicide is or includes an ester. In additional embodiments, the herbicide is or includes a substituted urea. In others, the the herbicide is or includes a biphenol ether.

In one or more embodiments, the pesticide composition identified above or elsewhere herein includes a pesticide that is an insecticide. In one or more embodiments, insecticide is or includes a carbamate. In other embodiments, the insecticide is or includes an organophosphate. In others, the insecticide is or includes a synthetic pyrethroid. In still others, the insecticide is or includes a chloronicotinyl. In yet others, the insecticide is or includes a biological insecticide; or a fiprole.

In one or more embodiments, the pesticide composition identified above or elsewhere herein includes a pesticide that is a fungicide. In one or more embodiments, the fungicide is or includes a strobilurin. In others, the fungicide is or includes a triazole. In yet others, the fungicide is or includes a dithiocarbomate.

Another specific embodiment of this invention includes a method of applying a pesticide to crops, including applying to the crops a composition that includes a pesticide, water, a surfactant and a polyalphaolefin, wherein the polyalphaolefin has a viscosity less than 4 cSt.

In the method identified above, or elsewhere herein, the pesticide includes a herbicide.

In the method identified above, or elsewhere herein, the pesticide includes a fungicide.

In the method identified above, or elsewhere herein, the pesticide includes a insecticide.

Another specific embodiment of this invention includes a method of preparing a pesticide composition, including mixing water and pesticide with a crop oil concentrate that includes a surfactant and a component that includes a polyalphaolefin, wherein the polyalphaolefin has a viscosity less than 4 cSt.

In one or more specific embodiments of the method identified above or elsewhere herein the component that includes a polyalphaolefin additionally includes a petroleum-based oil.

In one or more specific embodiments of the method identified above or elsewhere herein, the component that includes a polyalphaolefin occupies from about 70 to about 90 weight percent of the crop oil concentrate.

In one or more specific embodiments of the method identified above or elsewhere herein, the component that includes a polyalphaolefin occupies from about 80 to about 85 weight percent of the crop oil concentrate.

In one or more specific embodiments of the method identified above or elsewhere herein the pesticide includes (or is) a herbicide. In one or more embodiments, the pesticide includes a fungicide. In one or more embodiments, the pesticide includes an insecticide.

Pesticides

In one embodiment according to the present invention, the crop oil concentrate includes one or more pesticides. The pesticides include, but are not limited to, herbicides, insecticides and fungicides. The pesticides are used individually or in combination in the crop oil concentrate. In another embodiment according to the present invention, the crop oil concentrate is pesticide-free and is added to a second component, such as a carrier or diluent, having a pesticide.

Herbicides useful in crop oil concentrates are exemplified by triazines such as Atrazine, Simozine, Propazine, Cyanozine, Prometrine, and Metrobuzin; Phenoxys such as 2,4-dichlorophenoxyacetic acid (2,4-D), amine salts of 2,4-D such as 2,4-Damine 500 and esters of 2,4-D such as 2,4-D Ester LV600 and 2,4-D Ester LV700, Dicamba, and Bromoxynil, sulfonyl ureas such as Rimsulfuron and Nicosulfuron; substituted ureas such as Linuron and Diuron; biphenol ethers such as bentazon, acifluorfen, and lactofen; Graminicides such as Clodinafop ethyl, Fluazifop, Quizalofop, Sethoxodim, and Clethodim; Glyphosate; and Imidazolinones such as Imazethatyr and Imatauin. The herbicides are used individually or in mixtures of two or more herbicides in the COC.

Insecticides useful in crop oil concentrates are exemplified by carbamates such as Sevin and Furadan; organophosphates such as Malathion, Methyl Parathion and Diazinon; synthetic pyrethroids such as Cypermethrin and Deltamethrin; chloronicotinyls such as Imidaclodrid; biological insecticides such as Bacillus thuringiensis, Bacillus subtillis and Spinosads; fiproles such as fipronil; and dormant spray oils such as Sunspray 7E and Orchex 796. The insecticides are used individually or as mixtures of two or more insecticides in the COC.

Fungicides useful in crop oil concentrates are exemplified by strobilurins, such as Azxystrobin and Kresoxim-methyl; triazoles such as Propaconazole and Tebuconazole; and dithiocarbamates Maneb and Mancozeb. The fungicides are used individually or as mixtures of two or more fungicides in the COC.

Additionally, in one embodiment according to the present invention, the COC comprises a PAO, a surfactant, and water used in combination with two or more pesticides selected from herbicides, insecticides and fungicides. In another embodiment the COC comprises a PAO, a surfactant and a combination of at least two pesticides selected from herbicides, insecticides and fungicides.

Surfactants

Surfactants useful in COCs include, but are not limited to, non-ionic and anionic surfactants. Non-ionic surfactants useful in COCs include, but are not limited to, alkyl phenol ethoxylates (Nonyl, Dinonyl, Octyl, and Dodecyl phenols) having from about 4 and about 10 moles of ethylene oxide; alcohol ethoxylates (Linear C-12 to C-18 alcohols) having about 4 to about 10 moles of ethylene oxide; sorbitan esters (Sorbitan mono, di and tri oleates; Sorbitan mono, di- and tri-laureates) and their reaction products incorporating from about 15 to about 20 moles of ethylene oxide; alkyl polyglycosides; and organo silicone surfactants.

Anionic surfactants are also useful in crop oil concentrates. Anionic surfactants include, but are not limited to, phosphate esters of alkyl phenols and alcohol ethoxylates described in the preceding paragraph and carboxylates of the alkyl phenol and alcohol ethoxylates described in the preceding paragraph.

Although the function of an individual surfactant is dependent on the specific crop oil formulation in which it is used, typical functions of some non-ionic surfactants are as follows. The ethoxylated nonionic surfactants function as primary emulsifiers. The sorbitan esters (not ethoxylated) function as both coupling agents and secondary emulsifiers. The alkyl polyglycosides function as compatibility agents for high electrolyte tank mixes. The organo silicones are used as superspreading surfactants.

Typical functions of anionic surfactants include, but are not limited to, acting as secondary emulsifiers, as compatibility agents for high electrolyte tank mixes, and as acidifying agents to reduce the pH of the spray mixes.

Oils

Polyalphaolefins (PAOs) showed unexpected results when evaluated as a replacement for the petroleum oil component in a typical crop oil concentrate formulation. PAO-based crop oil concentrate testing demonstrated the effectiveness of a PAO-based COC as an adjuvant in controlling weeds relative to the petroleum-based industry COC standard, Agri-dex®. The results of the field-testing are shown in Tables 1 and 2. The field-testing in soybeans with Select™ herbicide and in corn with Accent™ herbicide shows that the PAO-based COC is as effective at 50-75% of the treat rate compared to the petroleum based COC standard. In addition, the PAO-based COC shows low phytotoxicity, e.g., causing no injury to the crops. The field-testing demonstrated the advantages of using PAO in place of the petroleum oil component in crop oil concentrate adjuvants, with the PAO-based COC showing superior enhancement of herbicide efficacy.

One embodiment according to the present invention uses low viscosity PAOs having viscosities ranging from about 0.1 cSt to about 10 cSt at 100° C. as determined by ASTM D 445. In another embodiment according to the present invention, the PAOs have a viscosity ranging from about 1 cSt to about 10 cSt, preferably from about 1 cSt to about 4 cSt and more preferably from about 1.5 cSt to about 2.5 cSt. Low viscosity PAOs include, but are not limited to, SHF grades SHF-20, 21, and 23, available from ExxonMobil Chemical Company. Another embodiment according to the present invention uses a 2 cSt PAO. Viscosities are reported, unless otherwise noted, as kinematic viscosity at 100° C. as determined by ASTM D 445.

In one embodiment according to the present invention, the PAOs have a weight average molecular weight ranging from about 110 to about 700; preferably from about 200 to about 700; more preferably from about 220 to about 350.

In another embodiment according to the present invention, the PAOs have a pour point less than or equal to about −48° C., preferably less than or equal to about −57° C., more preferably about −57° C.

In another embodiment according to the present invention, the PAOs have a specific gravity ranging from about 0.798 to about 0.835 grams/cm³; 15.5/15.6° C. as determined by ASTM D 4052.

In one embodiment according to the present invention, the PAO comprises an oligomer or a mixture of oligomers of at least one linear alphaolefin. Typically, the oligomer comprises a dimer, trimer, tetramer, pentamer, hexamer, or heptamer of the linear alphaolefin. In another embodiment according to the present invention, the mixture of oligomers comprises at least two oligomers selected from the group of dimers, trimers, tetramers, pentamers, hexamers, and heptamers. The linear alphaolefin comprises olefins having from about 4 to about 20 carbon atoms, preferably having from about 8 to about 16 carbon atoms, more preferably having from about 8 to about 14 carbon atoms. Specific olefins suitable for PAOs include, but are not limited to, 1-butene, 1-pentene, 1-hexene, 1-heptene, 1-octene, 1-nonene, 1-decene, 1-undecene and 1-dodecene. PAOs are described more particularly in, for example, U.S. Pat. Nos. 5,171,908 and 5,783,531, which are fully incorporated by reference. Additional description of PAOs is provided in SYNTHETIC LUBRICANTS AND HIGH-PERFORMANCE FUNCTIONAL FLUIDS, pp.1-52, Leslie R. Rudnick & Ronald L. Shubkin, eds., Marcel Dekker, Inc. 1999.

In another embodiment according to the present invention, the PAO may be prepared by oligomerization of linear alphaolefins, described in the preceding paragraph, in the presence of either a Lewis acid catalyst or a chromium catalyst as disclosed in U.S. Pat. Nos. 4,872,073 and 4,827,064, which are fully incorporated by reference. The desired oligomers are separated by any conventional method including, for example, by distillation. The desired oligomers have a boiling point, at atmospheric pressure, ranging from about 98° C. to about 396° C., preferably from about 250° C. to about 396° C., and more preferably from about 260° C. to about 340° C.

The oligomer is formed by oligomerizing a single alphaolefin feed or a mixed alphaolefin feed. The mixed alphaolefin feed comprises two or more alphaolefins. The mixture of oligomers includes mixtures in which all oligomers are each the product of the same alphaolefin, i.e., a single alphaolefin feed is used. Alternatively, the mixture of oligomers comprises oligomeric species each of which is the product of a mixed alphaolefin feed. Additionally, the mixture of oligomers may comprise oligomeric species each separately prepared from a single alphaolefin feed or a mixed alphaolefin feed and then blended to form the mixture of oligomers.

The improved effectiveness of the PAO-based crop oil over mineral oil based products in crop oil concentrates is unexpected. Although not wishing to be bound by any particular theory, the relatively low volatility and/or uniform structure of the PAO versus a mineral oil of comparable molecular weight may explain these findings. The lower volatility of the PAO allows the herbicide solution to remain on the leaves for an extended time period. Petroleum-based oils, in contrast, have higher volatility at the same molecular weight compared to PAOs as shown in Table 1. The relatively low viscosity of the 2 cSt PAO also facilitates the wetting of the weeds. In addition, the uniform structure of the PAO molecules compared to mineral oil may allow better penetration of the herbicide through the waxy cuticles of the weeds.

TABLE 1

| | Kinematic | Noack Volatility | |
|---|---|---|---|
| | Viscosity | wt % | Flash Point |
| | cSt | DIN 51581 or | ° C. |
| Method | ASTM D 445 | ASTM D 5800* | ASTM D 92 |
| Polyalphaolefin* | 4.1 | 14.0 | 220 |
| Polyalphaolefin* | 5.8 | 6.4 | 246 |
| Polyalphaolefin* | 8.0 | 3.3 | 260 |
| Polyalphaolefin* | 10.0 | 3.2 | 266 |
| Mineral Oil, Group II | 4.1 | 26.0* | 213 |
| Mineral Oil, Group II | 6.4 | 11.4* | 230 |
| Mineral Oil, Group II | 12.4 | 2.0* | 270 |

*SHF typical properties

Other Components

Crop oil concentrates optionally comprise a defoamer, for example, dimethyl siloxane. Crop oil concentrates also optionally comprise fatty acids and water, both of which function as coupling and clarifying agents to fully solubilize the emulsifier components into the finished crop oil concentrate. The fatty acids include, but are not limited to, oleic acid, linoleic acid, lauric acid, and mixtures of acids, such as tall oil.

Crop Oil Concentrates

In one embodiment according to the present invention, a crop oil concentrate comprises a PAO and a surfactant, typically for use with water and an active ingredient. The active ingredient comprises at least one of the herbicides, insecticides or fungicides described above.

In another embodiment the COC comprises a low viscosity PAO in which the viscosity is less than or equal to about 10 cSt, preferably less than or equal to about 4 cSt, and more preferably less than or equal to about 2.5 cSt and a surfactant; typically for use with water and an active ingredient. The surfactant comprises at least one non-ionic surfactant or anionic surfactant. Alternatively, the surfactant comprises a mixture of at least two surfactants having at least one non-ionic surfactant and at least one anionic surfactant.

In one embodiment according to the present invention, the COC comprises from about 10 wt % to about 99 wt % PAO, preferably from about 25 wt % to about 90 wt % and most preferably from about 50 wt % to about 85 wt %, based on the total weight of the COC. In another embodiment according to the present invention, the COC comprises from about 2 wt % to about 80 wt % surfactant, preferably from about 10 wt % to about 50 wt % and most preferably from about 15 wt % to about 40 wt %, based on the total weight of the COC. The ranges of oil and surfactant may not always equal 100% as other additives of various types may be used in some of the formulations.

In another embodiment according to the present invention, the crop oil concentrate comprises a conventional oil, a surfactant and a PAO having a viscosity ranging from about 1 cSt to about 10 cSt, preferably a viscosity ranging from about 1 cSt to about 4 cSt, and more preferably from about 1.5 cSt to about 2.5 cSt at 100° C. In another embodiment, the PAO comprises more than about 25 wt % and preferably more than about 50 wt % of the total weight of the conventional oil and PAO present in the crop oil concentrate.

Another embodiment according to the present invention is a method of inhibiting growth of a weed comprising mixing a PAO having a viscosity ranging from about 1 cSt to about 10 cSt at 100° C. with a surfactant to form a crop oil concentrate, blending the crop oil concentrate with a mixture of a carrier, typically water, and a herbicide to form a herbicide solution and applying the herbicide solution to a field having the weed. In another embodiment according to the present invention, the method of inhibiting growth of a weed comprises mixing PAO having a viscosity ranging from about 1 cSt to about 4 cSt, more preferably from about 1.5 cSt to about 2.5 cSt at 100° C. with a surfactant to form a crop oil concentrate, blending the crop oil concentrate with a carrier and a herbicide to form a herbicide solution, and applying the herbicide solution. In a preferred embodiment, the method of inhibiting growth of a weed includes applying the herbicide solution to a field having both the weed and a crop plant. Typical crops include, but are not limited to, corn and soybean. In another embodiment according to the present invention, the method of inhibiting growth of a weed comprises mixing a PAO having a viscosity of about 2 cSt at 100° C. with a surfactant to form the crop oil concentrate, blending the crop oil concentrate with a carrier and a herbicide to form a herbicide solution, and applying the herbicide solution to a weed.

In another embodiment according to the present invention, the method of inhibiting growth of a weed comprises mixing a surfactant, a herbicide and a PAO having a viscosity ranging from about 1 cSt to about 10 cSt at 100° C. to form a crop oil concentrate, blending the crop oil concentrate with a carrier to form a herbicide solution, and applying the herbicide solution to a field having the weed. A preferred method comprises applying the herbicide solution to a field having the weed and a crop plant.

In another embodiment according to the present invention, the method of inhibiting growth of a weed comprises preparing a crop oil concentrate consisting essentially of a surfactant and a PAO having a viscosity ranging from about 1 cSt to about 10 cSt, preferably ranging from about 1 cSt to about 4 cSt, and more preferably ranging from about 1.5 cSt to about 2.5 cSt at 100° C. by mixing the PAO and the surfactant to form the crop oil concentrate, blending the crop oil concentrate with a carrier, typically water, and a herbicide to form a herbicide solution, and applying the herbicide solution onto the weed. In another embodiment, the method of inhibiting growth of a weed comprises blending a crop oil concentrate consisting essentially of a surfactant and a PAO having a viscosity ranging from about 1 cSt to about 10 cSt, preferably ranging from about 1 cSt to about 4 cSt, and more preferably ranging from about 1.5 cSt to about 2.5 cSt at 100° C. with a diluent containing a herbicide to form a diluted, herbicide containing crop oil concentrate and applying the diluted, herbicide containing crop oil concentrate to the weed. A preferred method comprises applying the diluted, herbicide containing crop oil concentrate to a field having the weed and a crop plant.

In another embodiment according to the present invention, the method of inhibiting growth of a weed comprises blending a crop oil concentrate consisting essentially of a surfactant, a herbicide and a PAO having a viscosity ranging from about 1 cSt to about 10 cSt, preferably ranging from about 1 cSt to about 4 cSt, and more preferably ranging from about 1.5 cSt to about 2.5 cSt at 100° C. with a carrier to form a herbicide application solution, and applying the herbicide application solution to the weed. A preferred method comprises applying the herbicide application solution to a field having both a weed and a crop plant.

In another embodiment according to the present invention, a pesticide composition comprises a PAO having a viscosity ranging from about 1 cSt to about 10 cSt, preferably ranging from about 1 cSt to about 4 cSt, and more preferably ranging from about 1.5 cSt to about 2.5 cSt at 100° C., a pesticide and a surfactant. In one embodiment according to the present invention, the pesticide comprises at least one of the herbicides, insecticides or fungicides described above. In another embodiment according to the present invention, the pesticide composition comprises a PAO having a viscosity ranging from about 1 cSt to about 10 cSt, preferably ranging from about 1 cSt to about 4 cSt, and more preferably ranging from about 1.5 cSt to about 2.5 cSt at 100° C., a pesticide and a surfactant wherein the pesticide comprises at least two pesticides selected from the herbicides, insecticides and fungicides described above. Optionally, the pesticide composition further comprises a carrier, typically water.

The foregoing disclosure and description of the invention are illustrative and explanatory thereof, and various changes in the details of the illustrated composition and construction and method of operation may be made without departing from the spirit of the invention. Additionally, one embodiment according to the present invention replaces a portion of a conventional oil or a mixture of at least two conventional oils with a PAO having a viscosity ranging from about 1 cSt to about 10 cSt at 100° C., preferably about 2 cSt at 100° C. The conventional oils include petroleum-based oil, mineral oil, vegetable oil, and animal oil. The mineral oils include paraffinic, isoparaffinic and cycloparaffinic oils. The vegetable oil includes soybean oil, canola oil, castor oil, corn oil, cotton seed oil, and sesame seed oil. Other conventional oils are methylated oils such as methylated soybean oil, methyl palmitate, and methyl oleate.

### EXAMPLE

A crop oil concentrate, COC A, was formulated with 2 cSt (kinematic viscosity at 100° C.) PAO and a non-ionic surfactant: 83 wt/wt % SHF-20 (available from ExxonMobil Chemical Corporation) and 17 wt/wt % Atplus™ 300F (available from Uniqema). The effectiveness of COC A compared to Agri-dex® was demonstrated by a field test in soybeans with Select™ herbicide and in corn with Accent™ herbicide.

Plots of soybeans and corn, consisting of 4 rows 30 inches apart and 30 feet in length, were planted. Prior to planting, Johnsongrass seeds were broadcast using a spinning disk spreader and the plot area was cultivated. Treatments were applied to the center 2 rows of each plot.

For soybeans, treatments consisted of either Select™ applied at 3 fluid oz/acre (oz/ac) product plus various adjuvant treatments in a spray volume of 10 gallons/acre. The various adjuvant treatments included Agri-dex® at the standard 1.0 % v/v treat rate, and COC A at 1.0 % v/v, 0.75 % v/v, and 0.5 % v/v. A treatment of Select™ with no adjuvant was included as a baseline treatment.

For corn, treatments consisted of either Accent™ applied at 0.5 oz/ac product plus various adjuvant treatments in a spray volume of 10 gallons/acre. The various adjuvant treatments included the Agri-dex® at the standard 1.0 % v/v treat rate, and COC A at 1.0 % v/v, 0.75 % v/v, and 0.5 % v/v. A treatment of Accent™ with no adjuvant was included as a baseline treatment.

Treatments were applied about 3.5 weeks following planting, when the soybeans were at the 4th trifoliolate leaf stage and the corn was at the 5th leaf stage. Johnsongrass seedlings were 12 to 15 inches in height at this time. Treatments were applied using a hand-held boom consisting of 3 nozzles spaced 20 inches apart with flat-fan nozzles. Carbon dioxide was used as the propellant.

Plots were visually rated for crop injury (0 to 100 percent, where 0 equals no injury and 100 equals complete death) and Johnsongrass control (0 to 100 percent, where 0 equals no control and 100 equals complete control). Ratings were taken at 7, 14, and 30 days after treatment (DAT).

Table 2 summarizes the weed control results with the Select™ herbicide. At the 7, 14 and 30 DAT ratings, the PAO-based COC at 0.5%, 0.75%, and 1% v/v use rates was as effective as Agri-dex® at 1% v/v in enhancing Select™ efficacy on Johnsongrass.

TABLE 2
Effect of Adjuvant Treatments on Johnsongrass
control (percent) with Select ™ Herbicide

| | Product | Rate | 7 DAT | 14 DAT | 30 DAT |
|---|---|---|---|---|---|
| 1 | Select ™ | 3 FL OZ/A | 39 | 33 | 23 |
| 2 | Select ™ | 3 FL OZ/A | 76 | 92 | 99 |
| 2 | COC A | 0.5% V/V | | | |
| 3 | Select ™ | 3 FL OZ/A | 78 | 92 | 99 |
| 3 | COC A | 0.75% V/V | | | |
| 4 | Select ™ | 3 FL OZ/A | 82 | 92 | 98 |
| 4 | COC A | 1% V/V | | | |
| 5 | Select ™ | 3 FL OZ/A | 78 | 92 | 96 |
| 5 | Agri-dex ® | 1% V/V | | | |

| | | | |
|---|---|---|---|
| LSD (P = .10) | 10 | 6 | 12 |

Table 3 summarizes the weed control results with the Accent™ herbicide. At the 7, 14 and 30 DAT ratings, the PAO-based COC at 0.75% and 1% v/v use rates was as effective as Agri-dex® at 1% v/v in enhancing Accent™ efficacy on Johnsongrass.

TABLE 3
Effect of Adjuvant Treatments on Johnsongrass
control (percent) with Accent ™ Herbicide

| | Product | Rate | 7 DAT | 14 DAT | 30 DAT |
|---|---|---|---|---|---|
| 1 | Accent ™ | 0.5 OZ WT/A | 23 | 31 | 38 |
| 2 | Accent ™ | 0.5 OZ WT/A | 36 | 53 | 68 |
| | COC A | 0.5% V/V | | | |
| 3 | Accent ™ | 0.5 OZ WT/A | 45 | 53 | 73 |
| | COC A | 0.75% V/V | | | |
| 4 | Accent ™ | 0.5 OZ WT/A | 50 | 58 | 83 |
| | COC A | 1% V/V | | | |
| 5 | Accent ™ | 0.5 OZ WT/A | 48 | 53 | 80 |
| | Agri-dex ® | 1% V/V | | | |

| | | | |
|---|---|---|---|
| LSD (P = .10) | 8 | 9 | 12 |

None of the treatments in Tables 2 and 3 caused any visible injury to either the soybean or corn (0% injury at 7, 14, and 30 DAT for all treatments).

We claim:

1. A crop oil concentrate comprising a polyalphaolefin and a surfactant, wherein the polyalphaolefin has a viscosity ranging from about 0.1 cSt to about 10 cSt and comprises an oligomer of at least one linear alphaolefin having from 8 to 16 carbon atoms.

2. The crop oil concentrate according to claim 1, wherein the viscosity of the polyalphaolefin ranges from about 1.5 cSt to about 2.5 cSt.

3. The crop oil concentrate according to claim 1, wherein the polyalphaolefin has a pour point less than or equal to about −48° C.

4. The crop oil concentrate according to claim 1, wherein the polyalphaolefin has a number average molecular weight ranging from about 110 to about 700.

5. A crop oil concentrate comprising a polyalphaolefin and a surfactant, wherein the polyalphaolefin has a viscosity ranging from about 0.1 cSt to about 10 cSt and comprises an oligomer of at least one linear alphaolefin having 8 or more carbon atoms.

6. The crop oil concentrate according to claim 1, wherein the surfactant is an anionic surfactant.

7. The crop oil concentrate according to claim 1, wherein the surfactant is a non-ionic surfactant.

8. The crop oil concentrate according to claim 1, wherein the surfactant is a cationic surfactant.

9. The crop oil concentrate according to claim 1, wherein the surfactant includes tallow amine ethoxylate.

10. A crop oil concentrate comprising a polyalphaolefin, a surfactant and a pesticide.

11. The crop oil concentrate according to claim 10, wherein the polyalphaolefin has a viscosity ranging from about 0.1 cSt to about 10 cSt.

12. The crop oil concentrate according to claim 11, wherein the polyalphaolefin has a viscosity ranging from about 1.5 cSt to about 2.5 cSt.

13. The crop oil concentrate according to claim 10, wherein the surfactant is a non-ionic surfactant.

14. The crop oil concentrate according to claim 13, wherein the surfactant is an anionic surfactant.

15. The crop oil concentrate according to claim 10, wherein the polyalphaolefin has a pour point less than or equal to about −48° C.

16. The crop oil concentrate according to claim 10, wherein the polyalphaolefin has a number average molecular weight ranging from about 110 to about 700.

17. The crop oil concentrate according to claim 10, wherein the polyalphaolefin comprises an oligomer of at least one linear alphaolefin and wherein the linear alphaolefin has from about 8 to about 16 carbon atoms.

18. A crop oil concentrate comprising a polyalphaolefin, a surfactant, and water, wherein the polyalphaolefin has a viscosity ranging from about 0.1 cSt to about 10 cSt.

19. The crop oil concentrate according to claim 18, wherein the viscosity of the polyalphaolefin ranges from about 1.5 cSt to about 2.5 cSt.

20. The crop oil concentrate according to claim 18, wherein the polyalphaolefin has a pour point less than or equal to about −48 ° C.

21. The crop oil concentrate according to claim 18, wherein the polyalphaolefin has a number average molecular weight ranging from about 110 to about 700.

22. The crop oil concentrate according to claim 18, wherein the polyalphaolefin comprises an oligomer of at least one linear alphaolefin and wherein the linear alphaolefin has 8 or more carbon atoms.

23. The crop oil concentrate according to claim 18, wherein the surfactant is an anionic surfactant.

24. The crop oil concentrate according to claim 23, wherein the surfactant is a non-ionic surfactant.

25. A crop oil concentrate comprising a conventional oil, a surfactant and a PAO having a viscosity ranging from about 1 cSt to about 10 cSt, wherein the PAO comprises more than about 25 wt % of the total weight of the conventional oil and the PAO in the crop oil concentrate.

26. The crop oil concentrate of claim 25, wherein the viscosity of the PAO ranges from about 1.5 cSt to about 2.5 cSt at 100° C.

27. The crop oil concentrate of claim 25, wherein the PAO comprises more than about 50 wt % of the total weight of the conventional oil and the PAO in the crop oil concentrate.

28. A method of inhibiting growth of a weed, the method comprising mixing a PAO having a viscosity ranging from about 1 cSt to about 10 cSt at 100° C. with a surfactant to form a crop oil concentrate; blending the crop oil concentrate with a mixture of a carrier and a herbicide to form a herbicide solution; and applying the herbicide solution to a field having the weed.

29. The method according to claim 28, wherein the viscosity of the PAO ranges from about 1.5 cSt to about 2.5 cSt at 100° C.

30. A method of inhibiting growth of a weed, the method comprising mixing a surfactant, a herbicide and a PAO having a viscosity ranging from about lcSt to about 10 cSt at 100° C. to form a crop oil concentrate, blending the crop oil concentrate with a carrier and a herbicide to form a herbicide solution, and applying the herbicide solution to a field having the weed.

31. A pesticide composition comprising a PAO having a viscosity ranging from about 1 cSt to about 10 cSt at 100° C., a pesticide and a surfactant.

32. The pesticide composition of claim 31, wherein the PAO has a viscosity ranging from about 1.5 to about 2.5 cSt at 100° C.

33. A crop oil concentrate according to claim 1, wherein the polyalphaolefin comprises an oligomer formed from or including at least one linear alphaolefin having from 8 to 10 carbon atoms.

34. A crop oil concentrate according to claim 1, wherein the polyalphaolefin has a viscosity of 4 cSt or less.

35. A crop oil concentrate according to claim 1, wherein the polyalphaolefin has a viscosity ranging from 1 cSt to 4 cSt.

36. A crop oil concentrate according to claim 1, wherein the polyalphaolefin has a viscosity of 5 cSt or less.

37. A crop oil concentrate according to claim 1, wherein the crop oil concentrate has a viscosity of from 1.1 to 13 cSt.

38. A crop oil concentrate according to claim 1, wherein the crop oil concentrate has a viscosity of 2.5 to 7 cSt.

39. A crop oil concentrate according to claim 1, wherein the crop oil concentrate has a viscosity of 13 cSt or less.

40. A crop oil concentrate according to claim 1, wherein the crop oil concentrate has a viscosity of 8 cSt or less.

41. A crop oil concentrate according to claim 1, wherein the surfactant includes an ethoxylate or ester.

42. A crop oil concentrate according to claim 1, wherein the surfactant includes a member selected from the group consisting of alkyl phenol ethoxylates (Nonyl, Dinonyl, Octyl, and Dodecyl phenols) having from about 4 and about 10 moles of ethylene oxide; alcohol ethoxylates (Linear C-12 to C-18 alcohols) having about 4 to about 10 moles of ethylene oxide; sorbitan esters (Sorbitan mono, di and tri oleates; Sorbitan mono, di- and tri- laureates) and their reaction products incorporating from about 15 to about 20 moles of ethylene oxide; alkyl polyglycosides; organo silicone surfactants; amides; and a block copolymer of ethylene oxide and propylene oxide.

43. A crop oil concentrate according to claim 1, wherein the surfactant includes an alcohol or phenol.

44. A crop oil concentrate according to claim 1, wherein the surfactant includes phosphate esters of alkyl phenols and alcohol ethoxylates and carboxylates of the alkyl phenols and alcohol ethoxylates.

45. A crop oil concentrate according to claim 1, further comprising a defoamer.

46. A crop oil concentrate according to claim 1, further comprising a siloxane compound.

47. A crop oil concentrate according to claim 1, further comprising dimethyl siloxane.

48. A crop oil concentrate according to claim 1, further comprising a fatty acid.

49. A crop oil concentrate according to claim 1, further comprising a defoamer and a fatty acid.

50. A pesticide composition comprising a pesticide and a polyalphaolefin.

51. The pesticide composition of claim 50 further comprising water.

52. The pesticide composition of claim 50 further comprising a surfactant.

53. The pesticide composition of claim 50 in which the polyalphaolefin has a viscosity of 4 cSt or less.

54. The pesticide composition of claim 50 in which the pesticide is a herbicide.

55. The pesticide composition of claim 54 in which the herbicide is or includes a triazine compound.

56. The pesticide composition of claim 54 in which the herbicide is or includes a phenoxy compound.

57. The pesticide composition of claim 54 in which the herbicide is or includes an amine salt compound.

58. The pesticide composition of claim 54 in which the herbicide is or includes an ester.

59. The pesticide composition of claim 54 in which the herbicide is or includes a substituted urea.

60. The pesticide composition of claim 54 in which the herbicide is or includes a biphenol ether.

61. The pesticide composition of claim 50 in which the pesticide is an insecticide.

62. The pesticide composition of claim 61 in which the insecticide is or includes a carbamate.

63. The pesticide composition of claim 61 in which the insecticide is or includes an organophosphate.

64. The pesticide composition of claim 61 in which the insecticide is or includes a synthetic pyrethroid.

65. The pesticide composition of claim 61 in which the insecticide is or includes a chloronicotinyl.

66. The pesticide composition of claim 61 in which the insecticide is or includes a biological insecticide.

67. The pesticide composition of claim 61 in which the insecticide is or includes a fiprole.

68. The pesticide composition of claim 50 in which the pesticide is a fungicide.

69. The pesticide composition of claim 68 in which the fungicide is or includes a strobilurin.

70. The pesticide composition of claim 68 in which the fungicide is or includes a triazole.

71. The pesticide composition of claim 68 in which the fungicide is or includes a dithiocarbomate.

72. A method of applying a pesticide to crops, comprising applying to the crops a composition that includes a pesticide, water, a surfactant and a polyalphaolefin, wherein the polyalphaolefin has a viscosity less than 4 cSt.

73. The method of claim 72, in which the pesticide includes a herbicide.

74. The method claim 72, in which the pesticide includes a fungicide.

75. The method claim 72, in which the pesticide includes a insecticide.

76. A method of preparing a pesticide composition, comprising mixing water and pesticide with a crop oil concentrate that includes a surfactant and a component that includes a polyalphaolefin, wherein the polyalphaolefin has a viscosity less than 4 cSt.

77. The method of claim 76, in which the component that includes a polyalphaolefin additionally includes a petroleum-based oil.

78. The method of claim 76, in which the component that includes a polyalphaolefin occupies from about 70 to about 90 weight percent of the crop oil concentrate.

79. The method of claim 76, in which the component that includes a polyalphaolefin occupies from about 80 to about 85 weight percent of the crop oil concentrate.

80. The method claim 76, in which the pesticide includes a herbicide.

81. The method claim 76, in which the pesticide includes a fungicide.

82. The method claim 76, in which the pesticide includes a insecticide.
